(19) United States
(12) Patent Application Publication
(10) Pub. No.: US 2026/0318781 A1
(43) Pub. Date: Oct. 15, 2026

(54) SYNTHETIC DUST FOR GAS TURBINE ENGINE TESTING AND RELATED METHODS

(71) Applicant: General Electric Company, Evendale, OH (US)

(72) Inventors: Balasubramaniam Ponnuchamy, Bangalore (IN); Byron A. Pritchard, Loveland, OH (US); Michael H. Fisher, Ocala, FL (US); Jeremy C. Bailey, Liberty Township, OH (US); Eeshani Paresh Godbole, Niskayuna, NY (US); Ambarish J. Kulkarni, Glenville, NY (US); Ameesha Pandita, Delhi (IN); Rachel Marie Sorell, Albany, NY (US)

(21) Appl. No.: 19/643,229

(22) Filed: Apr. 9, 2026

(30) Foreign Application Priority Data
Apr. 10, 2025 (IN) 202511035093

(51) Int. Cl. G01M 15/14; C04B 35/626

(52) U.S. Cl. CPC G01M 15/14; C04B 35/62605

(57) ABSTRACT

Synthetic dust for gas turbine engine testing and related methods are disclosed herein. An example non-transitory computer readable medium disclosed herein includes instructions which, when executed, cause one or more processors to determine a first material composition of an ambient dust reservoir collected at a test site for a gas turbine engine, determine a plurality of differences between the first material composition and a second material composition of a target dust, and prepare a synthetic dust based on the plurality of differences.

### RELATED APPLICATIONS

This patent arises from Indian Provisional Application No. 202511035093, which was filed on Apr. 10, 2025. Indian Provisional Application No. 202511035093 is hereby incorporated herein by reference in its entirety. Priority to Indian Provisional Application No. 202511035093 is hereby claimed.

### FIELD OF THE DISCLOSURE

This disclosure relates generally to gas turbine engine testing methodologies and, more particularly, to synthetic dust for gas turbine engine testing and related methods.

### BACKGROUND

Turbine engines are some of the most widely used power-generating technologies, often being utilized in aircraft and power-generation applications. A turbine engine generally includes a fan and a core arranged in flow communication with one another. The core of the turbine engine generally includes, in serial flow order, a compressor section, a combustion section, a turbine section on the same shaft as the compressor section, and an exhaust section. Typically, a casing or housing surrounds the core of the turbine engine. During operation, air and ambient particulate matter are drawn into the gas turbine engine. In some operating conditions, the ingested particulate matter can affect the internal components and/or operation of the gas turbine engine.

### BRIEF DESCRIPTION OF THE DRAWINGS

FIG. 1 is a block diagram of an example testing environment including an example dust preparation circuitry that operates to prepare a synthetic dust for use in the testing of a gas turbine engine.

FIG. 2 is a block diagram of an example implementation of the dust preparation circuitry of FIG. 1.

FIG. 3A is a schematic diagram illustrating the determination of the composition of the synthetic dust of FIG. 1 by the dust preparation circuitry of FIGS. 1 and 2.

FIG. 3B is a table illustrating the determination of the particle size distribution of the synthetic dust of FIG. 1 by the dust preparation circuitry of FIGS. 1 and 2.

FIG. 3C is a map depicting a target region from which a target dust can be collected.

FIG. 4 is a flowchart representative of example machine readable instructions and/or example operations that may be executed, instantiated, and/or performed by example programmable circuitry to implement the dust preparation circuitry of FIGS. 1 and 2.

FIG. 5 is a block diagram of an example processing platform including programmable circuitry structured to execute, instantiate, and/or perform the example machine readable instructions and/or perform the example operations of FIG. 4 to implement the dust preparation circuitry of FIGS. 1 and 2.

In general, the same reference numbers will be used throughout the drawing(s) and accompanying written description to refer to the same or like parts. The figures are not necessarily to scale.

### DETAILED DESCRIPTION

During testing and certification, gas turbine engines are operated in conditions that simulate conditions similar to the operating conditions of harsh environments on Earth. One test involved in simulating these harsh conditions involves the intake of synthetic dust to simulate operating in regions with a large amount of airborne particulate matter, such as the Middle East. Prior tests involved operating gas turbine engines on a testing rig at ground level, which exposes the gas turbine engine to dust in the ambient environment of the testing location. This ambient dust exhibits characteristics that are different than the tailored synthetic dust and the dust associated with the targeted harsh operating regions. This ambient dust affects the gas turbine engine testing and can cause inaccurate results. Examples disclosed herein include an example method and apparatus to generate synthetic dust that accurately simulates the dust of harsh environments and accounts for the ambient dust present in the testing environment. Examples disclosed herein include determining the dust load, mineral composition, and particle size of the ambient dust of the testing environment. Examples disclosed herein include formulating synthetic dust with a mineral composition, dust load, and particle size that simulate the dust of a targeted hostile environment when ingested into a gas turbine engine with the ambient dust of the testing environment. Examples disclosed herein enhance the accuracy of gas turbine engine dust intake testing by accurately replicating the conditions of targeted hostile environments.

As used herein, the term “dust” refers to the particulate matter that can be ingested into a gas turbine engine during the operation and/or testing thereof. As used herein, dust can include mineral dust (e.g., quartz, clay, feldspars, iron oxide, silicates, sulfates, calcite, salt, halite, phosphate, aluminum oxide, calcium carbonate, magnesium carbonate, gypsum, goethite, etc.), industrial dust (e.g., soot, other carbonaceous dust, metal powders, plastic dust, other industrial waste, etc.), and/or organic matter (e.g., sawdust, pollen, molds, fragments of plants, fragments of animals, other bioaerosols, etc.). As used herein, the term “ambient dust reservoir” refers to the dust present in a testing environment of a component. As used herein, the term “dust load” refers to the amount (i.e., volume, mass, etc.) of dust that is expected to be ingested into a component during testing. As used herein, the term “ambient dust load” refers to the portion of the dust load associated with the ambient dust reservoir (e.g., the amount of dust from the ambient dust reservoir that is expected to be ingested into a component during testing, etc.). As used herein, the term “target dust” and related terms refer to the dust characteristics (e.g., the material composition of the target dust, the density of the target dust, the particle size distribution of the target dust, etc.) of a region being targeted/simulated by a test.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Regulatory agencies and manufacturers subject gas turbine engines to a variety of testing during the certification thereof. One of these tests is a dust endurance test, which operates a gas turbine engine in a testing environment that simulates the dust conditions of targeted harsh environments, such as the Middle East. Dust endurance tests test the resistance of the hot sections of gas turbine engines to wear associated with the intake of a large amount of dust. During dust endurance tests, synthetic dust is distributed into the testing environment and ingested into the gas turbine engine during the test. This synthetic dust is formulated to simulate the dust of the targeted harsh environment. Prior methods include formulating synthetic dust that replicates the dust of the targeted harsh environment. However, during prior dust endurance tests, dust from the ambient testing environment is also ingested into the gas turbine engine. The combination of the ambient dust and the synthetic dust increases the overall dust load of the gas turbine and can result in an ingested dust load with a mineral composition and particle size distribution that is not reflective of the dust in the targeted harsh environments. Accordingly, this mixture of synthetic dust and ambient dust can result in inaccurate endurance test results.

Examples disclosed herein overcome some or all of the above-noted deficiencies and include methods and apparatus to formulate synthetic dust that accounts for ambient dust loads and accurately simulate the targeted dust of harsh environments. Examples disclosed herein include analyzing a sample of dust from a testing environment and determining the dust load, mineral composition, and particle size distribution thereof. Examples disclosed herein include adjusting the mineral and the particle size distribution of the synthetic dust based on the characteristics of the analyzed dust sample. Examples of synthetic dust loads disclosed herein are prepared to simulate the targeted dust load when ingested into a gas turbine engine with the ambient dust load. Examples disclosed herein enhance the accuracy of gas turbine engine dust intake testing by accurately replicating the conditions of targeted hostile environments. Examples disclosed herein enable the preparation of synthetic dust that can be tailored to a variety of targeted harsh environments.

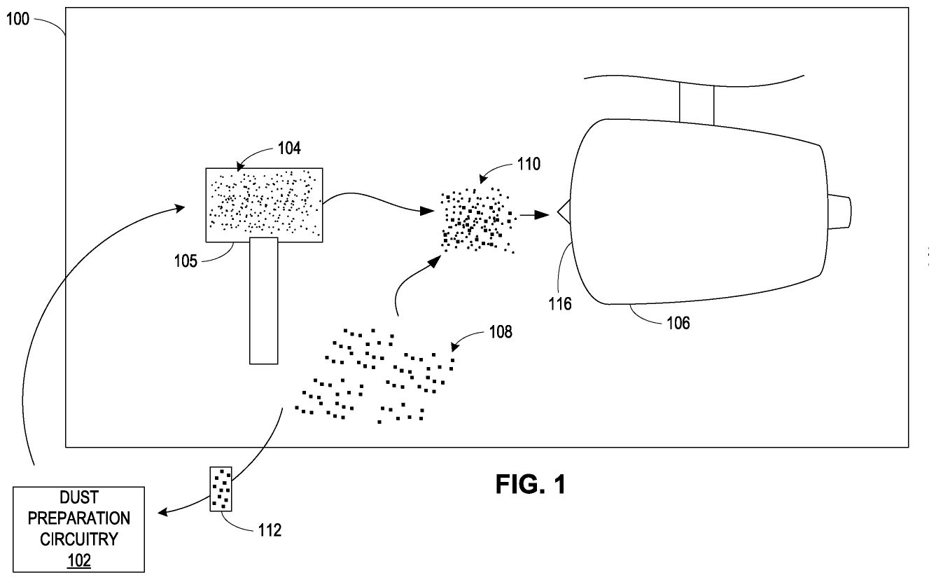

FIG. 1 is a block diagram of an example testing environment 100 including a dust preparation circuitry 102 and a synthetic dust 104 implemented in accordance with the teachings of this disclosure. In the illustrated example of FIG. 1, the synthetic dust 104 is loaded in a synthetic test repository 105. In the illustrated example of FIG. 1, the testing environment 100 includes a gas turbine engine 106 and an ambient dust reservoir 108. During testing, the gas turbine engine 106 intakes a dust load 110. In the illustrated example of FIG. 1, the dust preparation circuitry 102 analyzes a dust sample 112 of the ambient dust reservoir 108 and prepares the synthetic dust 104.

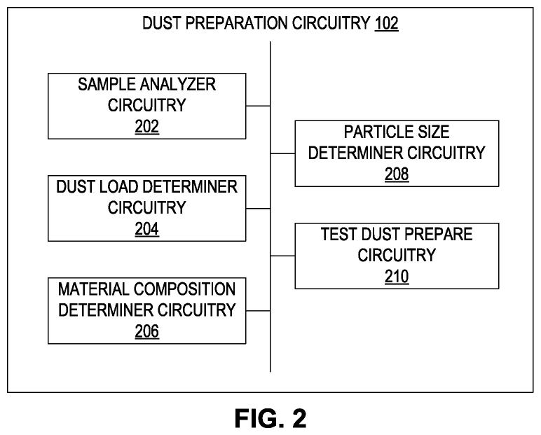

The testing environment 100 is the area in which the gas turbine engine 106 is being subject to a dust endurance test and/or another test that includes the ingestion of dust into the gas turbine engine 106. In some examples, the testing environment 100 is an enclosed facility (e.g., the testing environment 100, etc.). In some examples, the testing environment 100 is in a region that is dissimilar to the region targeted by the testing of the gas turbine engine 106 (e.g., the testing environment 100 is in a temperate climate, the testing environment 100 is in a wet climate, etc.). In other examples, the testing environment 100 is an outdoor location. In the illustrated example of FIG. 2, the testing environment 100 includes the ambient dust reservoir 108, which may be ingested into the gas turbine engine 106 during the operation and testing thereof. In some examples, the characteristics of the ambient dust reservoir 108 can be based on the local flora and fauna of the testing environment 100, the industrial activity in the area surrounding the testing environment 100, the geology of the testing environment 100, and/or the weather of the testing environment 100.

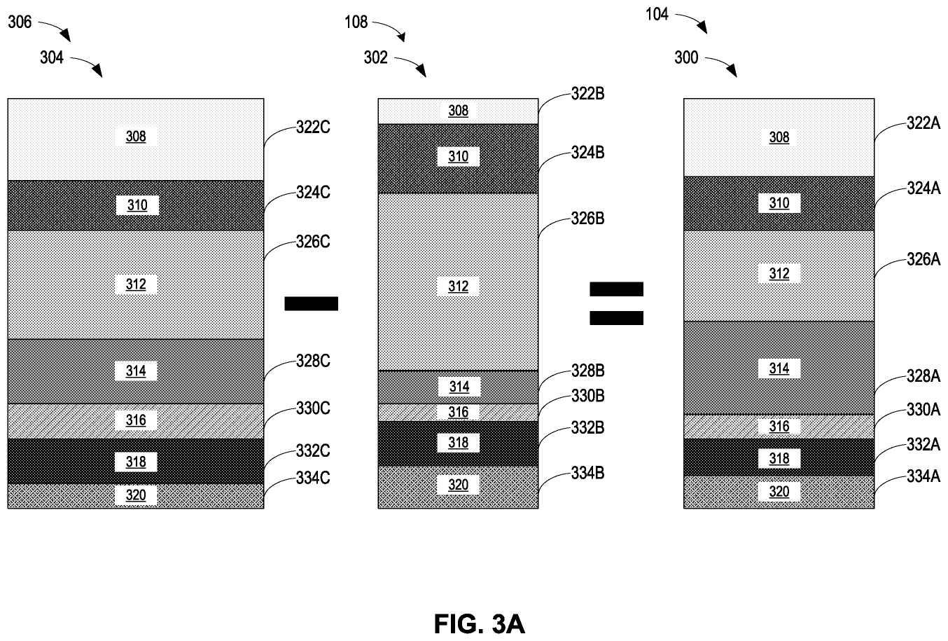

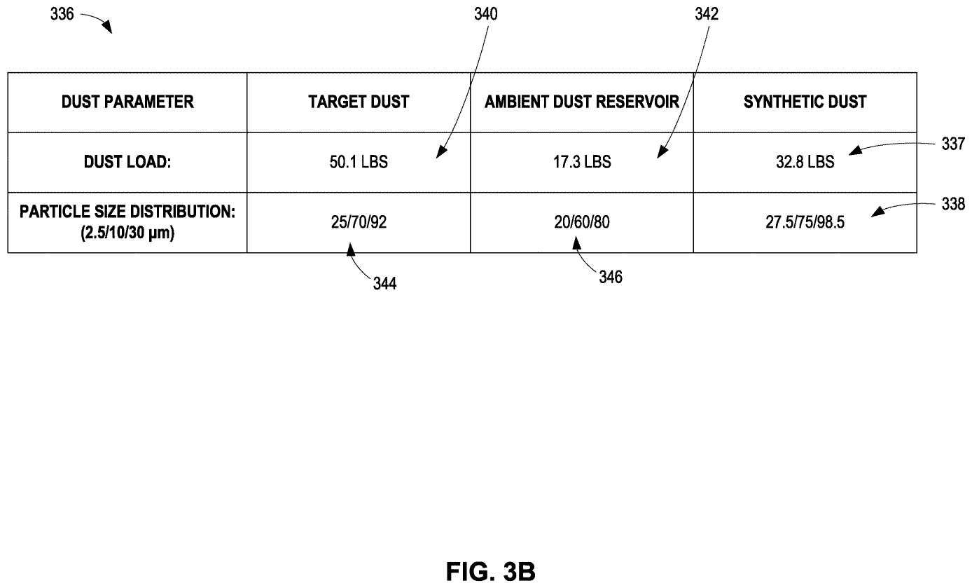

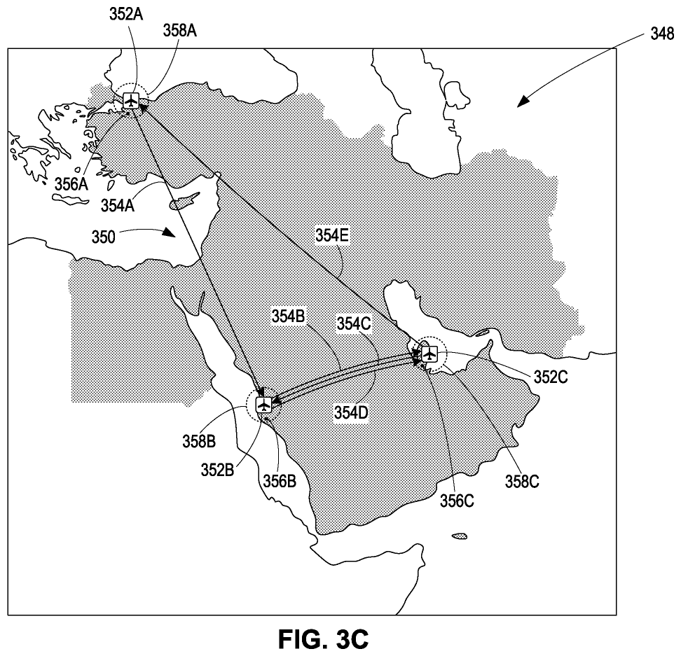

The synthetic dust 104 is an artificial dust that has been prepared by the dust preparation circuitry 102. In some examples, the synthetic dust 104 is formulated such that the dust load 110 has substantially the same characteristics as the ambient dust of a target region. For example, the characteristics (e.g., material distribution, particle size distribution, etc.) of the synthetic dust 104 can be tailored to account for the dilutional effect of the ambient dust reservoir 108, such that the dust ingested by the gas turbine engine 106 (e.g., a mixture of the synthetic dust 104 and dust from the ambient dust reservoir 108, etc.) has substantially the same characteristics as the ambient dust of the target region. In some examples, the volume and characteristics of the synthetic dust 104 can be tailored such that the dust load 110 ingested by the gas turbine engine 106 is substantially the same as the dust of a target region. As used herein, a dust is “substantially the same” as another dust if the characteristics of those dusts are within 5% (e.g., the dust is within the 5% of the total volume of the other dust, each material of the material compositions of the dusts is within 5% of the corresponding material composition of the other dust, etc.). In some examples, the target region associated with the dust load 110 is a region with a comparatively high density of ambient dust, such as the Middle East, India, and China. The preparation of the synthetic dust 104 is described below in additional detail in conjunction with FIGS. 3A and 3B.

The gas turbine engine 106 is a turbomachinery assembly that undergoes dust endurance testing. In some examples, the gas turbine engine 106 is undergoing certification with a regulatory agency. The gas turbine engine 106 can be implemented by any suitable type of gas turbine engine 106 including a turbofan, a turbojet, a turboprop, a turboshaft, and/or another type of turbomachinery. In the illustrated example of FIG. 1, the gas turbine engine 106 includes an inlet 116. During operation, the gas turbine engine 106 intakes air and the dust load 110 via the inlet 116. In the illustrated example of FIG. 2, the dust load 110 is a mixture of the synthetic dust 104 and dust of the ambient dust reservoir 108. Components and/or portions of the gas turbine engine 106, such as the hot section of the gas turbine engine 106, may be sensitive (e.g., susceptible to wear and tear, etc.) to the flow of the dust load 110 therethrough. While examples disclosed herein are described with reference to the gas turbine engine 106, the examples disclosed herein are not limited thereto. Instead, examples disclosed herein are also applicable to any type of mechanical assembly that may be sensitive to dust intake.

In the illustrated example of FIG. 1, the dust preparation circuitry 102 analyzes a dust sample 112 taken from the ambient dust reservoir 108 to determine the characteristics of the dust of the ambient dust reservoir 108. For example, the dust preparation circuitry 102 can determine the composition, the particle size distribution, and/or the density of the dust of the ambient dust reservoir 108. In some examples, the dust preparation circuitry 102 can prepare (e.g., mix, formulate, fabricate, manufacture, etc.) the synthetic dust 104. In other examples, the dust sample 112 can be analyzed at the testing environment 100 (e.g., via a mobile testing device, etc.) and/or at a third location (e.g., a geology laboratory, etc.). In the illustrated example of FIG. 1, the dust preparation circuitry 102 is depicted as external to the testing environment 100 (e.g., the dust preparation circuitry 102 is located in a different facility, etc.). In other examples, the dust preparation circuitry 102 can be disposed in/at the testing environment 100. The dust preparation circuitry 102 is described below in additional detail in conjunction with FIG. 2.

FIG. 2 is a block diagram of an example implementation of the dust preparation circuitry 102 of FIG. 1 to prepare a synthetic dust sample load based on a dust sample and a target dust composition. In the illustrated example of FIG. 2, the dust preparation circuitry 102 includes sample analyzer circuitry 202, dust load determiner circuitry 204, material composition determiner circuitry 206, particle size determiner circuitry 208, and synthetic dust preparer circuitry 210.

The dust preparation circuitry 102 of FIG. 2 may be instantiated (e.g., creating an instance of, bringing into being for any length of time, materialize, implement, etc.) by programmable circuitry such as a Central Processor Unit (CPU) executing first instructions. Additionally or alternatively, the dust preparation circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The sample analyzer circuitry 202 receives the dust sample 112 from the testing environment 100. For example, the sample analyzer circuitry 202 receives the dust sample 112 of FIG. 1 and/or an analysis of the dust sample 112 of FIG. 1. For example, the sample analyzer circuitry 202 can receive the dust sample 112 for analysis via one or more microscopes, spectroscopes, centrifuges, x-ray diffraction devices, thermal analysis devices, Fourier infrared spectroscopy instruments, etc. In some such examples, the sample analyzer circuitry 202 can receive the dust sample 112 in more or more vessels (e.g., test tubes, microscope slides, etc.). Additionally, or alternatively, the sample analyzer circuitry 202 can receive an analysis of the dust sample 112 conducted at the testing environment 100 of FIG. 1 (e.g., via one or more field instruments, etc.) and/or at a third location (e.g., a mineralogy testing facility, etc.).

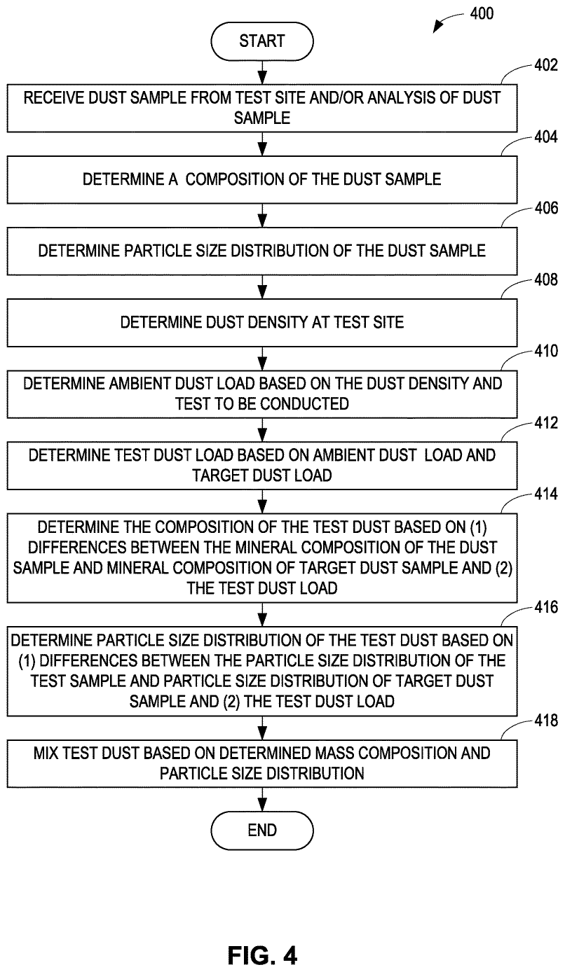

The sample analyzer circuitry 202 can determine the composition and/or the particulate size distribution of the dust sample 112. For example, the sample analyzer circuitry 202 can determine the relative composition (e.g., relative volume, relative mass, etc.) and/or the particle size distribution of the dust sample 112 via mineralogy analysis. Additionally or alternatively, the sample analyzer circuitry 202 can determine the second composition 302 and/or the particulate size distribution based on the received dust sample analysis. In some examples, the sample analyzer circuitry 202 is instantiated by programmable circuitry executing sample analyzer instructions and/or configured to perform operations such as those represented by the flowchart of FIG. 4.

The dust load determiner circuitry 204 determines the synthetic dust load of the synthetic dust 104 of FIG. 1. In some examples, the dust load determiner circuitry 204 can determine the synthetic dust load based on the difference between the target dust load associated with the test to be conducted on the gas turbine engine 106 and the dust load associated with ambient dust load. In some examples, the synthetic dust load can be determined based on the duration of the test to be conducted on the gas turbine engine 106, the speed profile of the test to be conducted on the gas turbine engine 106, and/or the properties of the region the test is modeling (e.g., the density of dust at the target region, the flight profile being modeled by the test, etc.).

In some examples, the dust load determiner circuitry 204 determines the ambient dust load based on the dust density of the ambient dust reservoir 108 and the test to be conducted. For example, the dust load determiner circuitry 204 can determine the ambient dust load based on a product of the dust density of the ambient dust reservoir 108 and the duration of the test to be conducted on the gas turbine engine 106. In some examples, the dust load determiner circuitry 204 can also determine the ambient dust load based on the engine speed profile (e.g., the engine speed(s) that the gas turbine engine 106 is to operate at over the course of the dust endurance test, etc.) over the duration of the test to be conducted on the gas turbine engine 106 (e.g., faster speeds of the gas turbine engine 106 cause a greater dust ingestion rate, etc.). In some examples, the dust load determiner circuitry 204 identifies (e.g., determines, etc.) the dust density of the ambient dust reservoir 108 at the testing environment 100 based on the dust sample 112. Additionally, or alternatively, the dust load determiner circuitry 204 can identify (e.g., determine, etc.) the dust density at the testing environment 100 based on prior testing (e.g., records of prior testing, etc.) in the testing environment 100, weather records at the testing environment 100, and/or other sampling/testing conducting at the testing environment 100. In some examples, the dust load determiner circuitry 204 is instantiated by programmable circuitry executing dust load determiner instructions and/or configured to perform operations such as those represented by the flowcharts of FIG. 4.

The material composition determiner circuitry 206 determines the composition of the synthetic dust 104 of FIG. 1. For example, the material composition determiner circuitry 206 can determine the relative portions (e.g., relative mass portions, relative volume portions, etc.) of the materials of the synthetic dust 104. In some examples, the material composition determiner circuitry 206 can determine the absolute portions (e.g., the mass of each material, the volume of each material, etc.) associated with the synthetic dust 104. The determination of the composition of the synthetic dust 104 of FIG. 1 is described below in additional detail in conjunction with FIG. 3A. In some examples, the material composition determiner circuitry 206 is instantiated by programmable circuitry executing mineral composition determiner instructions and/or configured to perform operations such as those represented by the flowchart of FIG. 4.

The particle size determiner circuitry 208 determines the particle size distribution of the synthetic dust based on (1) differences between the particle size distribution of the dust sample 112 and the particle size distribution of the target dust and (2) the synthetic dust load. For example, the particle size determiner circuitry 208 determines the synthetic particle size distribution such that the synthetic dust 104, when ingested with the dust of the ambient dust reservoir 108, has the same particle size distribution as the target dust. The determination of the particle size distribution of the synthetic dust 104 of FIG. 1 is described below in additional detail in conjunction with FIG. 3B. In some examples, the particle size determiner circuitry 208 is instantiated by programmable circuitry executing particle size determiner instructions and/or configured to perform operations such as those represented by the flowcharts of FIG. 4.

The synthetic dust preparer circuitry 210 mixes the synthetic dust 104. For example, the synthetic dust preparer circuitry 210 can prepare (e.g., mix, etc.) the synthetic dust 104 such that the synthetic dust 104 has the material composition determined by the material composition determiner circuitry 206 and the particle size determiner circuitry 208. In some examples, the synthetic dust preparer circuitry 210 can select material dust with appropriate particle sizes and prepare the selected material(s) in a mixing chamber. Additionally, or alternatively, the synthetic dust preparer circuitry 210 can generate a list of materials (e.g., a list of materials and corresponding masses/volumes, etc.) to facilitate the mixing of the materials by a technician (e.g., by hand, via a machine, etc.). In some examples, after the mixing of the synthetic dust 104 by the synthetic dust preparer circuitry 210, the synthetic dust 104 is transported to the testing environment 100, loaded into the synthetic test repository 105 of FIG. 1, and released for ingestion into the gas turbine engine 106 during the testing thereof. In some examples, the synthetic dust preparer circuitry 210 is instantiated by programmable circuitry executing synthetic dust mixer instructions and/or configured to perform operations such as those represented by the flowcharts of FIG. 4.

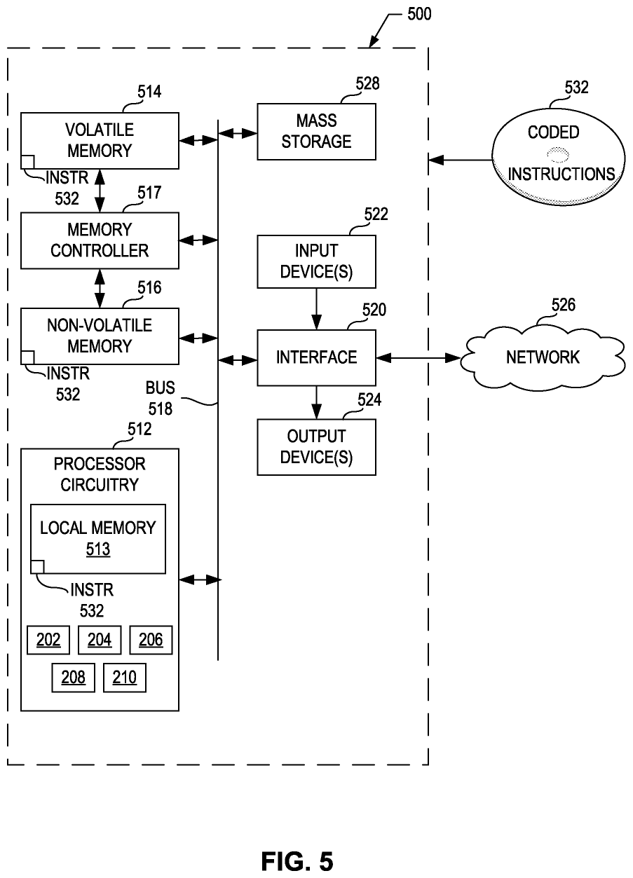

In some examples, the dust preparation circuitry 102 includes means for analyzing a dust sample, means for determining a dust load, means for determining a material composition of a synthetic dust, means for determining a particle size distribution, and means for mixing a synthetic dust. For example, the means for analyzing a dust sample may be implemented by the sample analyzer circuitry 202, means for determining a dust load may be implemented by the dust load determiner circuitry 204, means for determining a material composition of synthetic dust may be implemented by the material composition determiner circuitry 206, the means for determining a particle size distribution may be implemented by the particle size determiner circuitry, and/or the means for mixing synthetic dust may be implemented by the synthetic dust preparer circuitry 210. In some examples, the sample analyzer circuitry 202, the dust load determiner circuitry 204, the material composition determiner circuitry 206, the particle size determiner circuitry 208, and/or the synthetic dust preparer circuitry 210 may be instantiated by programmable circuitry such as the example programmable circuitry 512 of FIG. 5. For instance, the synthetic dust preparer circuitry 210. In some examples, the sample analyzer circuitry 202, the dust load determiner circuitry 204, the material composition determiner circuitry 206, the particle size determiner circuitry 208, and/or the synthetic dust preparer circuitry 210 may be instantiated by an example microprocessor executing machine executable instructions such as those of FIG. 4. In some examples, the synthetic dust preparer circuitry 210. In some examples, the sample analyzer circuitry 202, the dust load determiner circuitry 204, the material composition determiner circuitry 206, the particle size determiner circuitry 208, and/or the synthetic dust preparer circuitry 210 may be instantiated by hardware logic circuitry, which may be implemented by an ASIC, XPU, or the FPGA circuitry configured and/or structured to perform operations corresponding to the machine readable instructions. Additionally, or alternatively, the synthetic dust preparer circuitry 210. In some examples, the sample analyzer circuitry 202, the dust load determiner circuitry 204, the material composition determiner circuitry 206, the particle size determiner circuitry 208, and/or the synthetic dust preparer circuitry 210 may be instantiated by any other combination of hardware, software, and/or firmware. For example, the synthetic dust preparer circuitry 210. In some examples, the sample analyzer circuitry 202, the dust load determiner circuitry 204, the material composition determiner circuitry 206, the particle size determiner circuitry 208, and/or the synthetic dust preparer circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example implementation of the dust preparation circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the sample analyzer circuitry 202, the dust load determiner circuitry 204, the material composition determiner circuitry 206, the particle size determiner circuitry 208, the synthetic dust preparer circuitry 210, and/or, more generally, the dust preparation circuitry 102 of FIG. 2, may be implemented by hardware alone or by hardware in combination with software and/or firmware. Thus, for example, any of the sample analyzer circuitry 202, the dust load determiner circuitry 204, the material composition determiner circuitry 206, the particle size determiner circuitry 208, the synthetic dust preparer circuitry 210, and/or, more generally, the dust preparation circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the dust preparation circuitry 102 of FIG. 2 may include one or more elements, processes, and/or devices in addition to, or instead of, those illustrated in FIG. 2, and/or may include more than one of any or all of the illustrated elements, processes and devices.

FIG. 3A is a schematic diagram illustrating the determination of a first composition 300 of the synthetic dust 104 of FIG. 1 by the dust preparation circuitry 102 of FIGS. 1 and 2. In the illustrated example of FIG. 2, the first composition 300 is determined based on a second composition 302 of the ambient dust reservoir 108, and a third composition 304 of a target dust load 306. In some examples, the target dust load 306 is substantially similar to the dust load 110 of FIG. 1. That is, the first composition 300 is determined such that the composition of the dust load 110 of FIG. 1 is substantially similar to the target dust load 306. An example process to determine the third composition 304 of a target dust load 306 is described below in conjunction with FIG. 3C.

In the illustrated example of FIG. 3A, the compositions 300, 302, 304 include a first material 308, a second material 310, a third material 312, a fourth material 314, a fifth material 316, a sixth material 318, and a seventh material 320. Each of the materials 308, 310, 312, 314, 316, 318, 320 corresponds to a different type of particulate matter, such as one or more mineral dust(s) (e.g., quartz, clay, feldspars, iron oxide, silicates, sulfates, calcite, salt, aluminum oxide, calcium carbonate, magnesium carbonate, gypsum, goethite, etc.), one or more industrial dust(s) (e.g., soot, other carbonaceous dusts, metal powders, plastic dusts, other industrial waste, etc.), and/or organic particulate matter(s) (e.g., sawdust, pollen, molds, fragments of plants, fragments of animals, other bioaerosols, etc.). For example, the first material 308 can be salt, the second material 310 can be gypsum, the third material 312 can be goethite, etc. That is, each of the compositions 300, 302, 304 includes corresponding portions of salt, gypsum, goethite, and/or other materials (e.g., a first portion of salt, a second portion of gypsum, a third portion of goethite, etc.).

In the illustrated example of FIG. 3A, each of the materials 308, 310, 312, 314, 316, 318, 320 is represented by a same fill pattern and/or color in each of the compositions 300, 302, 304. While the compositions 300, 302, 304 are depicted as including seven materials (e.g., the materials 308, 310, 312, 314, 316, 318, 320, etc.), it should be appreciated that the compositions 300, 302, 304 can include a different quantity of materials (e.g., 5 materials, 20 materials, 50 materials, 100 materials, etc.).

In the illustrated example of FIG. 3A, the total area of the compositions 300, 302, 304 represents the total dust load associated with each of the synthetic dust 104, the ambient dust reservoir 108, and the target dust load 306, respectively. For example, the total area of the compositions 300, 302, 304 can represent the total mass of the dust loads of the synthetic dust 104, the ambient dust reservoir 108, and the target dust load 306, respectively. In other examples, the total area of the compositions 300, 302, 304 correspond to the volume and/or weight of the total mass of the dust loads of the synthetic dust 104, the ambient dust reservoir 108, and the target dust load 306, respectively. In the illustrated example of FIG. 3A, the target dust load 306 is larger than the dust load associated with the ambient dust reservoir 108.

In the illustrated example of FIG. 3A, the first material 308 has a first synthetic material portion 322A in the first composition 300, a first ambient material portion 322B in the second composition 302, and a first target material portion 322C in the third composition 304. In the illustrated example of FIG. 3A, the second material 310 has a second synthetic material portion 324A in the first composition 300, a second ambient material portion 324B in the second composition 302, and a second target material portion 324C in the third composition 304. In the illustrated example of FIG. 3A, the third material 312 has a third synthetic material portion 326A in the first composition 300, a second ambient material portion 326B in the second composition 302, and a third target material portion 326C in the third composition 304. In the illustrated example of FIG. 3A, the fourth material 314 has a fourth synthetic material portion 328A in the first composition 300, a fourth ambient material portion 328B in the second composition 302, and a fourth target material portion 328C in the third composition 304. In the illustrated example of FIG. 3A, the fifth material 316 has a fifth synthetic material portion 330A in the first composition 300, a fifth ambient material portion 330B in the second composition 302, and a fifth synthetic material portion 330C in the third composition 304. In the illustrated example of FIG. 3A, the sixth material 318 has a sixth synthetic material portion 332A in the first composition 300, a sixth ambient material portion 332B in the second composition 302, and a sixth target material portion 332C in the third composition 304. In the illustrated example of FIG. 3A, the seventh material 320 has a seventh synthetic material portion 334A in the first composition 300, a seventh ambient material portion 334B in the second composition 302, and a seventh target material portion 334C in the third composition 304. Similarly to the total area of the compositions 300, 302, 304, the area of each of the material portions 322A, 322B, 322C, 324A, 324B, 324C, 326A, 326B, 326C, 328A, 328B, 328C, 330A, 330B, 330C, 332A, 332B, 332C, 334A, 334B, 334C represents the corresponding portion (e.g., volume, mass, weight, etc.) of the corresponding one of the material portions 322A, 322B, 322C, 324A, 324B, 324C, 326A, 326B, 326C, 328A, 328B, 328C, 330A, 330B, 330C, 332A, 332B, 332C, 334A, 334B, 334C.

The determination of the synthetic material portions 322A, 324A, 326A, 328A, 330A, 332A, of the synthetic dust 104 is defined by the following equations:

ρ_{T1}L_{T}−ρ_{A1}L_{A}=xₛ₁ (1)

ρ_{T2}L_{T}−ρ_{A2}L_{A}=xₛ₂ (2)

ρ_{T3}L_{T}−ρ_{A3}L_{A}=xₛ₃ (3)

ρ_{T4}L_{T}−ρ_{A4}L_{A}=xₛ₄ (4)

ρ_{T5}L_{T}−ρ_{A5}L_{A}=xₛ₅ (5)

ρ_{T6}L_{T}−ρ_{A6}L_{A}=xₛ₆ (6)

ρ_{T7}L_{T}−ρ_{A7}L_{A}=xₛ₇ (7),

where L_{T} is the total dust load of the target dust load 306, L_{A} is the total dust load of the ambient dust reservoir 108, xₛ₁ is the dust load of the first material 308, xₛ₂ is the dust load of the second material 310, xₛ₃ is the dust load of the third material 312, xₛ₄ is the dust load of the fourth material 314, xₛ₅ is the dust load of the fifth material 316, xₛ₆ is the dust load of the sixth material 318, xₛ₇ is the dust load of the seventh material 320, ρ_{T1} is the first target material portion 322C, ρ_{T2} is the second target material portion 324C, ρ_{T3} is the third target material portion 326C, ρ_{T4} is the fourth target material portion 328C, ρ_{T5} is the fifth target material portion 330C, ρ_{T6} is the sixth target material portion 332C, ρ_{T7} is the seventh target material portion 334C, ρ_{A1} is the first ambient material portion 322B, ρ_{A2} is the second ambient material portion 324B, ρ_{A3} is the third ambient material portion 326B, ρ_{A4} is the fourth ambient material portion 328B, ρ_{A5} is the fifth ambient material portion 330B, ρ_{A6} is the sixth ambient material portion 332B, and ρ_{A7} is the seventh ambient material portion 334C. That is, each of the synthetic material portions 322A, 324A, 326A, 328A, 330A, 332A, 334A can be determined based on the difference of (1) the product of the total dust load of the target dust load 306 and the corresponding one of the target material portions 322C, 324C, 326C, 328C, 330C, 332C, 334C and (2) the product of the total dust load of the ambient dust reservoir 108 and the corresponding one of the ambient material portions 322B, 324B, 326B, 328B, 330B, 332B, 334B.

FIG. 3B is a table 336 illustrating the determination of a synthetic dust load 337 and a synthetic particle size distribution 338 of the synthetic dust 104 of FIG. 1 by the dust preparation circuitry of FIGS. 1 and 2. In the illustrated example of FIG. 3B, the table 336 includes a target dust load 340 (e.g., the total dust load of the target dust load 306, Lr of equations (1)-(7), etc.), a ambient dust load 342 (e.g., the total dust load of the ambient dust reservoir 108, L_{A} of equations (1)-(7), etc.), and a synthetic dust load 337 of the synthetic dust 104, etc. The synthetic dust load 337 is the difference between the dust load associated with the target dust load 340 and the ambient dust load 342. That is, the target dust load 340 is the sum of the ambient dust load 342 and the synthetic dust load 337.

In the illustrated example of FIG. 3B, the table 336 includes a target particle size distribution 344 (e.g., a first particle size distribution, etc.) and an ambient particle size distribution 346 (e.g., a second particle size distribution, etc.). An example process to determine the target particle size distribution 344 of a target dust load 306 is described below in conjunction with FIG. 3C.

In the illustrated example of FIG. 3B, the particle size distributions 338, 344, 346 are represented with three thresholds, which correspond to the percentages of the particles of the corresponding dust with diameters less than 2.5 micrometers (μm), 10 μm, and 30 μm. For example, the target particle size distribution 344 includes 25% of particles with a diameter less than or equal to 2.5 μm, 70% of particles with a diameter less than or equal to 10 μm, 92% of particles with a diameter less than or equal to 30 μm. Similarly, the ambient particle size distribution 346 includes 20% of particles with a diameter less than or equal to 2.5 μm, 60% of particles with a diameter less than or equal to 10 μm, and 80% of particles with a diameter less than or equal to 30 μm. While three particle size distribution thresholds are described in conjunction with FIG. 3B (e.g., 2.5 μm, 10 μm, and 30 μm, etc.), it should be appreciated that additional or alternative particle size distribution thresholds can be used. For example, the particle size distributions 338, 344, 346 can be divided into a different quantity of thresholds (e.g., two thresholds, four thresholds, ten thresholds, etc.), which can have different thresholds.

To determine the synthetic particle size distribution 338, the following equation can be used for each of the thresholds:

$$\frac{{α}_{T} {L}_{T} - {α}_{A} {L}_{A}}{{L}_{S}} = {α}_{S} , \qquad ( 8 )$$

where L_{T} is the target dust load 340, L_{A} is the ambient dust load 342, L_{S} is the synthetic dust load 337, α_{T} is the percentage of the target dust load 340 below a given threshold, α_{A} is the percentage of the ambient dust load 342 below the given threshold, and the α_{S} is the percentage of the synthetic dust load 337 below the given threshold. In other examples, the synthetic particle size distribution 338 can be determined iteratively, via modeling and/or via one or more different analytical method(s).

FIG. 3C is a simplified map depicting a target region 348 including an example route 350 of an aircraft operating therein from which a target dust load can be determined. In the illustrated example of FIG. 3C, the target region 348 includes a first airport 352A, a second airport 352B, and a third airport 352C. In the illustrated example of FIG. 3C, the route 350 includes an example first flight path 354A, a second flight path 354B, a third flight path 354C, a fourth flight path 354D, and a fifth flight path 354E.

In the illustrated example of FIG. 3C, the target region 348 is the Middle East. In other examples, the target region 348 can be another part of the world with high dust loads (e.g., central Asia, Saharan Africa, northern India, the southwestern United States, etc.). In the illustrated example of FIG. 3C, the first airport 352A is Istanbul Airport, the second airport 352B is King Abdulaziz International Airport, and the third airport 352C is Dubai International Airport. Additionally or alternatively, dust associated with other airports can be used to determine a target dust load (e.g., additional airports, different airports, etc.). In some such examples, the airports considered when determining the target dust load depend on the path of the route 350.

In the illustrated example of FIG. 3C, the first airport 352A has an associated first collection site 356A, the second airport 352B has an associated second collection site 356B, and the third airport 352C has an associated third collection site 356C. The collection sites 356A, 356B, 356C are geographic locations that have ambient dusts that are substantially similar to the dusts at the airports 352A, 352B, 352C, respectively. That is, dusts collected from the collection sites 356A, 356B, 356C can be used as a proxy for the dusts that aircraft encounter at the airports 352A, 352B, 352C, respectively.

To determine suitable locations for the collection sites 356A, 356B, 356C, the first airport 352A is surrounded by a first collection zone 358A, the second airport 352B is surrounded by a second collection zone 358B, and the third airport 352C is surrounded by a third collection zone 358C. The collection zones 358A, 358B, 358C represent the region around which a target dust sample representative of the dust at the airports 352A, 352B, 352C can be collected. In some examples, the collection zones 358A, 358B, 358C have a radius of 100 miles around the airports 352A, 352B, 352C. In other examples, the collection zones 358A, 358B, 358C can be smaller than 100 miles (e.g., 30 miles, 40 miles, etc.) depending on the weather and/or climate patterns associated with the target region 348. In some examples, the collection sites 356A, 356B, 356C for the airports 352A, 352B, 352C are selected from within the collection zones 358A, 358B, 358C, respectively.

In some examples, other characteristics can be considered when selecting suitable locations for the collection sites 356A, 356B, 356C. For example, the collection sites 356A, 356B, 356C can be selected to have similar ambient conditions as the airports 352A, 352B, 352C, respectively. For example, some or all of the collection sites 356A, 356B, 356C can be selected to have similar ambient temperatures, similar ambient humidities, similar ambient soil moisture levels, similar levels of sun exposure, similar wind conditions, similar distances from the ocean (e.g., similar ambient salt levels, etc.) In some examples, the collection sites 356A, 356B, 356C can be selected based on the surrounding topography. In some such examples, the collection sites 356A, 356B, 356C can be selected such that the collection sites 356A, 356B, 356C are elevated from the ambient environment by at least an average ground clearance of an engine mounted on an aircraft—(e.g., five feet, ten feet, twenty feet, etc.). In some such examples, the relative elevation of the collection sites 356A, 356B, 356C represents the elevation of the aircraft-mounted engines during operation (e.g., the ground clearance of a mounted engine, the elevation of an engine during takeoff, etc.). For example, the collection sites 356A, 356B, 356C can be selected to be on a hill, a roof of a manmade structure, mounted on top of a poll, etc. In some examples, the dust at the collection sites 356A, 356B, 356C can be sampled periodically to reduce the seasonal variation thereof.

Dust collected from one or more of the collection zones 358A, 358B, 358C can be used to determine the third composition 304 of the target dust load 306 of FIG. 3A and/or the target particle size distribution 344 of FIG. 3B for the target region 348 and/or the route 350. For example, the third composition 304 and/or the target particle size distribution 344 can be determined based on an average composition and/or a particle size distribution of dust collected at the collection sites 356A, 356B, 356C. In other examples, the third composition 304 and/or the target particle size distribution 344 can be determined based on a most severe dust load (e.g., a greatest volume of dust load, a greatest volume of a particular material in the dust load, a greatest volume of a particular particle size, etc.) of the dust collected at the collection sites 356A, 356B, 356C.

In other examples, the third composition 304 and/or the target particle size distribution 344 can be determined based on a weighted average of composition and/or a particle size distribution of dust collected at the collection sites 356A, 356B, 356C. For example, in the illustrated example of FIG. 3A, the route 350 includes flights between the airports 352A, 352B, 352C. In the illustrated example of FIG. 3C, the route 350 involves one takeoff and landing at the first airport 352A (e.g., the takeoff of the first flight path 354A and the landing of the fifth flight path 354E, etc.), two takeoffs and landing at the second airport 352B (e.g., the takeoffs of the flight paths 354B, 354D, the landings of the flight paths 354A, 354C, etc.), and two takeoffs and landings at the third airport 352C (e.g., the takeoffs of the flight paths 354C, 354E, the landings of the flight paths 354B, 354D, etc.). As such, in the illustrated example of FIG. 3C, the third composition 304, and/or the target particle size distribution 344 can be determined by weighing (1) the characteristics of the dust collected at the first collection site 356A with a weight of one, (2) the characteristics of the dust collected at the second collection site 356B with a weight of two, and (3) the characteristics of the dust collected at the second collection site 356B with a weight of two.

A flowchart representative of example machine readable instructions, which may be executed by programmable circuitry to implement and/or instantiate the dust preparation circuitry 102 of FIG. 2 and/or representative of example operations which may be performed by programmable circuitry to implement and/or instantiate the dust preparation circuitry 102 of FIG. 2, are shown in FIG. 4. The machine readable instructions may be one or more executable programs or portion(s) of one or more executable programs for execution by programmable circuitry such as the programmable circuitry 512 shown in the example programmable circuitry platform 500 discussed below in connection with FIG. 5 and/or may be one or more function(s) or portion(s) of functions to be performed by programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4, many other methods of implementing the dust preparation circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or operations 400 that may be executed, instantiated, and/or performed by programmable circuitry to prepare a synthetic dust sample load based on a dust sample and a target dust composition. The example machine-readable instructions and/or the operations 400 of FIG. 3A begin at block 402, at which the sample analyzer circuitry 202 receives the dust sample 112 from the testing environment 100. For example, the sample analyzer circuitry 202 receives the dust sample 112 of FIG. 1 and/or an analysis of the dust sample 112 of FIG. 1. For example, the sample analyzer circuitry 202 can receive the dust sample 112 for analysis via one or more microscopes, spectroscopes, centrifuges, x-ray diffraction devices, thermal analysis devices, Fourier infrared spectroscopy instruments, etc. In some such examples, the sample analyzer circuitry 202 can receive the dust sample 112 in more or more vessels (e.g., test tubes, microscope slides, etc.). Additionally or alternatively, the sample analyzer circuitry 202 can receive an analysis of the dust sample 112 conducted at the testing environment 100 of FIG. 1 (e.g., via one or more field instruments, etc.) and/or at a third location (e.g., a mineralogy testing facility, etc.).

At block 404, the sample analyzer circuitry 202 determines the composition 302 of the dust sample 112. For example, the sample analyzer circuitry 202 can determine the relative composition (e.g., relative volume, relative mass, etc.) of the dust sample 112 via mineralogy analysis. Additionally or alternatively, the sample analyzer circuitry 202 can determine the composition 302 based on the received dust sample analysis. In some examples, the sample analyzer circuitry 202 can determine the ambient material portions 322B, 324B, 326B, 328B, 330B, 332B, 334B of the composition of FIG. 3. At block 406, the sample analyzer circuitry 202 determines the particle size distribution of the dust sample 112. For example, the sample analyzer circuitry 202 determines the ambient particle size distribution 346 of FIG. 3B via mineralogy analysis. Additionally or alternatively, the sample analyzer circuitry 202 can determine the ambient particle size distribution 346 based on the dust sample analysis received during the execution of block 402.

At block 408, the dust load determiner circuitry 204 determines the dust density of the ambient dust reservoir 108 at the testing environment 100. For example, the dust load determiner circuitry 204 can determine the dust density of the ambient dust reservoir 108 at the testing environment 100 based on the dust sample 112. In other examples, the dust load determiner circuitry 204 can determine the dust density at the testing environment 100 based on prior testing (e.g., records of prior testing, etc.) in the testing environment 100, weather records at the testing environment 100, and/or other sampling/testing conducting at the testing environment 100.

At block 410, the dust load determiner circuitry 204 determines the ambient dust load based on the dust density of the ambient dust reservoir 108 and the test to be conducted. For example, the dust load determiner circuitry 204 can determine the ambient dust load based on (1) the dust density of the ambient dust reservoir 108, (2) the duration of the test to be conducted on the gas turbine engine 106, and (3) the engine speed profile over the duration of the test to be conducted on the gas turbine engine 106 (e.g., faster speeds of the gas turbine engine 106 causes a greater dust ingestion rate, etc.). At block 412, the dust load determiner circuitry 204 determines the synthetic dust load based on the ambient dust load 342 of FIG. 3B and the target dust load 340 of FIG. 3B. For example, the dust load determiner circuitry 204 determines the synthetic dust load 337 of FIG. 3B based on the difference between the target dust load 340 of FIG. 3B and the ambient dust load 342 of FIG. 3B determined during the execution of block 412.

At block 414, the material composition determiner circuitry 206 determines the first composition 300 of FIG. 3A of the synthetic dust based on differences between the mineral composition of the dust sample 112 from the ambient dust reservoir 108 and the mineral composition of the target dust. For example, the material composition determiner circuitry 206 can determine the first composition 300 (e.g., each of the synthetic material portions 322A, 324A, 326A, 328A, 330A, 332A, 334A, etc.) via the equations (1)-(7) described in conjunction with FIG. 3A. In some examples, the material composition determiner circuitry 206 determines the composition of the volumes of each of the materials of the synthetic dust 104 of FIG. 1. In other examples, the material composition determiner circuitry 206 determines the composition of the masses and/or weights of each of the materials of the synthetic dust 104 of FIG. 1.

At block 416, the particle size determiner circuitry 208 determines the particle size distribution of the synthetic dust based on differences between (1) the particle size distribution of the dust sample 112 and the particle size distribution of the target dust and (2) the synthetic dust load. For example, the particle size determiner circuitry 208 determines the synthetic particle size distribution 338 such that the synthetic dust 104, when ingested with the dust of the ambient dust reservoir 108, has the same particle size distribution as the target dust. In some examples, the particle size determiner circuitry 208 via equation (8) described in conjunction with FIG. 3B.

At block 418, the synthetic dust preparer circuitry 210 mixes synthetic dust based on the first composition 300 determined during the execution of block 414 and the synthetic particle size distribution 338 determined during the execution of block 416. For example, the synthetic dust preparer circuitry 210 can select material dust with appropriate particle sizes and prepare (e.g., mixes, etc.) the selected material dust in a mixing chamber such that the synthetic dust 104 has the material composition determined during the execution of block 414 and the particle size distribution determined during the execution of block 416. In some examples, after the mixing of the synthetic dust 104 by the synthetic dust preparer circuitry 210, the synthetic dust 104 is transported to the testing environment 100, loaded into the synthetic test repository 105 of FIG. 1, and released for ingestion into the gas turbine engine 106 during the testing thereof. The operations 400 end.

FIG. 5 is a block diagram of an example programmable circuitry platform 500 structured to execute and/or instantiate the example machine-readable instructions and/or the example operations of FIG. 4 to implement the dust preparation circuitry 102 of FIG. 2. The programmable circuitry platform 500 can be, for example, a server, a personal computer, a workstation, a self-learning machine (e.g., a neural network), a mobile device (e.g., a cell phone, a smart phone, a tablet such as an iPad™), a personal digital assistant (PDA), a headset (e.g., an augmented reality (AR) headset, a virtual reality (VR) headset, etc.) or other wearable device, or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, DSPs, and/or microcontrollers from any desired family or manufacturer. The programmable circuitry 512 may be implemented by one or more semiconductor based (e.g., silicon based) devices. In this example, the programmable circuitry 512 implements the sample analyzer circuitry 202, the dust load determiner circuitry 204, the material composition determiner circuitry 206, the particle size determiner circuitry 208, and the synthetic dust preparer circuitry 210.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 532, which may be implemented by the machine readable instructions of FIGS. 4, may be stored in the mass storage device 528, in the volatile memory 514, in the non-volatile memory 516, and/or on at least one non-transitory computer readable storage medium such as a CD or DVD which may be removable.

From the foregoing, it will be appreciated that example systems, apparatus, articles of manufacture, and methods have been disclosed for synthetic dust for use with gas turbine engine testing. Examples synthetic dust loads disclosed herein are formulated to account for ambient dust load and simulate targeted dust load when ingested into a gas turbine engine therewith. Examples disclosed herein enhance the accuracy of gas turbine engine dust intake testing by accurately replicating the conditions of targeted hostile environments. Examples disclosed herein enable the preparation of synthetic dust that can be tailored to a variety of targeted harsh environments.

Further aspects are provided by the subject matter of the following clauses:

A non-transitory computer readable medium including instructions which, when executed, cause one or more processors to determine a first material composition of a sample of an ambient dust reservoir collected at a test site for a gas turbine engine, determine a plurality of differences between the first material composition and a second material composition of a target dust, and prepare a synthetic dust based on the plurality of differences.

The non-transitory computer readable medium of any preceding clause, wherein the first material composition includes a first portion of salt, a second portion of gypsum, and a third portion of goethite.

The non-transitory computer readable medium of any preceding clause, wherein the first material composition includes portions of at least seven materials.

The non-transitory computer readable medium of any preceding clause, wherein the instructions, when executed, cause the one or more processors to determine a first dust load associated with the ambient dust reservoir at the test site, and determine a second dust load for the synthetic dust based on a first difference between the first dust load and a third dust load of the target dust.

The non-transitory computer readable medium of any preceding clause, wherein instructions causes the one or more processors to determine the first dust load based on a duration of a test to be performed by the gas turbine engine and a density of the ambient dust reservoir at the test site.

The non-transitory computer readable medium of any preceding clause, wherein the instructions, when executed, cause the one or more processors to determine a first mass of a first material based on (1) a second difference of the plurality of differences and (2) the second dust load, and determine a second mass of a second material based on (1) a third difference of the plurality of differences and (2) the second dust load, the synthetic dust having the first mass of the first material and the second mass of the second material.

The non-transitory computer readable medium of any preceding clause, wherein the plurality of differences is a first plurality of differences, and the instructions, when executed, causes the one or more processors to determine a first particle size distribution of the ambient dust reservoir, determine a second plurality of differences between the first particle size distribution and a second particle size distribution of the target dust, and prepare the synthetic dust based on the second plurality of differences.

The non-transitory computer readable medium of any preceding clause, wherein a first difference of the first plurality of differences is based on a target dust load, a target portion of a first material, a total dust load of the ambient dust reservoir, and an ambient portion of the first material.

The non-transitory computer readable medium of any preceding clause, wherein a first difference of the second plurality of differences is based on a target load of a first material, a percentage of the target load of the first material below a first threshold, an ambient load of the first material, a percentage of the ambient load below the first threshold, and a synthetic dust load.

A method including determining a first material composition of a sample of an ambient dust reservoir collected at a test site for a gas turbine engine, determining a plurality of differences between the first material composition and a second material composition of a target dust, and preparing a synthetic dust based on the plurality of differences.

The method of any preceding clause, wherein the first material composition includes a first portion of salt, a second portion of gypsum, and a third portion of goethite.

The method of any preceding clause, wherein the first material composition includes portions of at least seven materials.

The method of any preceding clause, wherein preparing the synthetic dust further includes determining a first dust load associated with the ambient dust reservoir at the test site, and determining a second dust load for the synthetic dust based on a first difference between the first dust load and a third dust load of the target dust.

The method of any preceding clause, wherein the determining the first dust load is based on a duration of a test to be performed by the gas turbine engine and a density of the ambient dust reservoir at the test site.

The method of any preceding clause, wherein preparing the synthetic dust further includes determining a first mass of a first material based on (1) a second difference of the plurality of differences and (2) the second dust load, and determining a second mass of a second material based on (1) a third difference of the plurality of differences and (2) the second dust load, the synthetic dust having the first mass of the first material and the second mass of the second material.

The method of any preceding clause, wherein the plurality of differences is a first plurality of differences, the method further including determining a first particle size distribution of the ambient dust reservoir, determining a second plurality of differences between the first particle size distribution and a second particle size distribution of the target dust, and preparing the synthetic dust based on the second plurality of differences.

The method of any preceding clause, wherein a first difference of the first plurality of differences is based on a target dust load, a target portion of a first material, a total dust load of the ambient dust reservoir, and an ambient portion of the first material.

The method of any preceding clause, wherein a first difference of the second plurality of differences is based on a target load of a first material, a percentage of the target load of the first material below a first threshold, an ambient load of the first material, a percentage of the ambient load below the first threshold, and a synthetic dust load.

An apparatus comprising memory including machine readable instructions, and one or more processors to execute the machine readable instructions to determine a first material composition of a sample of an ambient dust reservoir collected at a test site for a gas turbine engine, determine a plurality of differences between the first material composition and a second material composition of a target dust, and prepare a synthetic dust based on the plurality of differences.

The apparatus of any preceding clause, wherein the first material composition includes a first portion of salt, a second portion of gypsum, and a third portion of goethite.

The apparatus of any preceding clause, wherein the processors are to execute the machine readable instructions to determine a first dust load associated with the ambient dust reservoir at the test site, and determine a second dust load for the synthetic dust based on a first difference between the first dust load and a third dust load of the target dust.

The apparatus of any preceding clause, wherein the processors are to execute the machine readable instructions to determine the first dust load based on a duration of a test to be performed by the gas turbine engine and a density of the ambient dust reservoir at the test site.

The apparatus of any preceding clause, wherein the one or more processors are to execute the machine readable instructions to determine a first mass of a first material based on (1) a second difference of the plurality of differences and (2) the second dust load, and determine a second mass of a second material based on (1) a third difference of the plurality of differences and (2) the second dust load, the synthetic dust having the first mass of the first material and the second mass of the second material.

The apparatus of any preceding clause, wherein the plurality of differences is a first plurality of differences, and the one or more processors are to execute the machine readable instructions to determine a first particle size distribution of the ambient dust reservoir, determine a second plurality of differences between the first particle size distribution and a second particle size distribution of the target dust, and prepare the synthetic dust based on the second plurality of differences.

The apparatus of any preceding clause, wherein a first difference of the plurality of first differences is based on a target dust load, a target portion of a first material, a total dust load of the ambient dust reservoir, and an ambient portion of the first material.

The apparatus of any preceding clause, wherein a first difference of the second plurality of differences is based on a target load of a first material, a percentage of the target load of the first material below a first threshold, an ambient load of the first material, a percentage of the ambient load below the first threshold, and a synthetic dust load.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory computer readable medium including instructions which, when executed, cause one or more processors to:
determine a first material composition of a sample of an ambient dust reservoir collected at a test site for a gas turbine engine;
determine a plurality of differences between the first material composition and a second material composition of a target dust; and
prepare a synthetic dust based on the plurality of differences.

2. The non-transitory computer readable medium of claim 1, wherein the first material composition includes a first portion of salt, a second portion of gypsum, and a third portion of goethite.

3. The non-transitory computer readable medium of claim 2, wherein the first material composition includes portions of at least seven materials.

4. The non-transitory computer readable medium of claim 1, wherein the instructions, when executed, cause the one or more processors to:
determine a first dust load associated with the ambient dust reservoir at the test site; and
determine a second dust load for the synthetic dust based on a first difference between the first dust load and a third dust load of the target dust.

5. The non-transitory computer readable medium of claim 4, wherein instructions causes the one or more processors to determine the first dust load based on a duration of a test to be performed by the gas turbine engine and a density of the ambient dust reservoir at the test site.

6. The non-transitory computer readable medium of claim 5, wherein the instructions, when executed, cause the one or more processors to:
determine a first mass of a first material based on (1) a second difference of the plurality of differences and (2) the second dust load; and
determine a second mass of a second material based on (1) a third difference of the plurality of differences and (2) the second dust load, the synthetic dust having the first mass of the first material and the second mass of the second material.

7. The non-transitory computer readable medium of claim 1, wherein the plurality of differences is a first plurality of differences, and the instructions, when executed, causes the one or more processors to:
determine a first particle size distribution of the ambient dust reservoir;
determine a second plurality of differences between the first particle size distribution and a second particle size distribution of the target dust; and
prepare the synthetic dust based on the second plurality of differences.

8. A method including:
determining a first material composition of a sample of an ambient dust reservoir collected at a test site for a gas turbine engine;
determining a plurality of differences between the first material composition and a second material composition of a target dust; and
preparing a synthetic dust based on the plurality of differences.

9. The method of claim 8, wherein the first material composition includes a first portion of salt, a second portion of gypsum, and a third portion of goethite.

10. The method of claim 9, wherein the first material composition includes portions of at least seven materials.

11. The method of claim 8, wherein preparing the synthetic dust further includes:
determining a first dust load associated with the ambient dust reservoir at the test site; and
determining a second dust load for the synthetic dust based on a first difference between the first dust load and a third dust load of the target dust.

12. The method of claim 11, wherein the determining the first dust load is based on a duration of a test to be performed by the gas turbine engine and a density of the ambient dust reservoir at the test site.

13. The method of claim 12, wherein preparing the synthetic dust further includes:
determining a first mass of a first material based on (1) a second difference of the plurality of differences and (2) the second dust load; and
determining a second mass of a second material based on (1) a third difference of the plurality of differences and (2) the second dust load, the synthetic dust having the first mass of the first material and the second mass of the second material.

14. The method of claim 8, wherein the plurality of differences is a first plurality of differences, the method further including:
determining a first particle size distribution of the ambient dust reservoir;
determining a second plurality of differences between the first particle size distribution and a second particle size distribution of the target dust; and
preparing the synthetic dust based on the second plurality of differences.

15. An apparatus comprising:
memory including machine readable instructions; and
one or more processors to execute the machine readable instructions to:
determine a first material composition of a sample of an ambient dust reservoir collected at a test site for a gas turbine engine;
determine a plurality of differences between the first material composition and a second material composition of a target dust; and
prepare a synthetic dust based on the plurality of differences.

16. The apparatus of claim 15, wherein the first material composition includes a first portion of salt, a second portion of gypsum, and a third portion of goethite.

17. The apparatus of claim 16, wherein the processors are to execute the machine readable instructions to:
determine a first dust load associated with the ambient dust reservoir at the test site; and
determine a second dust load for the synthetic dust based on a first difference between the first dust load and a third dust load of the target dust.

18. The apparatus of claim 17, wherein the processors are to execute the machine readable instructions to determine the first dust load based on a duration of a test to be performed by the gas turbine engine and a density of the ambient dust reservoir at the test site.

19. The apparatus of claim 18, wherein the one or more processors are to execute the machine readable instructions to:
determine a first mass of a first material based on (1) a second difference of the plurality of differences and (2) the second dust load; and
determine a second mass of a second material based on (1) a third difference of the plurality of differences and (2) the second dust load, the synthetic dust having the first mass of the first material and the second mass of the second material.

20. The apparatus of claim 15, wherein the plurality of differences is a first plurality of differences, and the one or more processors are to execute the machine readable instructions to:
determine a first particle size distribution of the ambient dust reservoir;
determine a second plurality of differences between the first particle size distribution and a second particle size distribution of the target dust; and
prepare the synthetic dust based on the second plurality of differences.
